(19) United States
(12) Patent Application Publication
(10) Pub. No.: US 2014/0262736 A1
(43) Pub. Date: Sep. 18, 2014

(54) METHOD AND DEVICE FOR RECYCLING WATER VAPOR EVAPORATED FROM COAL DRYING WITH VACUUM CONDENSING PROCESS

(71) Applicants: Tianhua Institute Of Chemical Machinery And Automation Co., Ltd., (US); National Engineering Research Center of Drying Technology and Equipment, (US)

(72) Inventors: Xu Zhao, Lanzhou (CN); Maikui Zhang, Lanzhou (CN); Tao Shen, Lanzhou (CN); Zhongfu Zhan, Lanzhou (CN)

(73) Assignees: National Engineering Research Center of Drying Technology and Equipment, Lanzhou (CN); TIANHUA INSTITUTE OF CHEMICAL MACHINERY AND AUTOMATION CO., LTD., Lanzhou (CN)

(21) Appl. No.: 13/800,267

(22) Filed: Mar. 13, 2013

(51) Int. Cl. C02F 1/06

(52) U.S. Cl. CPC C02F 1/06
USPC 203/11; 202/153

(57) ABSTRACT

A method is provided for purifying and recycling water vapor from a coal drying process and device which employ temperature reduction and dehumidifying, a flash distillation, and vacuum condensation. With a condensed tower, a high humidity exhaust gas is preliminarily lowered in temperature, and condensed water of 5˜60° C. is pumped, are received, vapor-liquid reverse contact is performed, and temperature reduction and dehumidifying occurs. With a flash distillation tank and a demisting washer, condensed water of 40˜100° C. pumped by the flash distillation water pump is performed on vacuum flash distillation, water vapor of 5˜60° C. evaporated in the flash distillation tank enters into the demisting washer to be dehumidified and then into a vapor condenser. With a condenser and a water ring vacuum pump, water vapor of 5˜60° C. is condensed through mist eliminating and washing by the demisting washer, condensed water is recycled, and non-condensable gas is discharged.

### FIELD OF THE INVENTION

The present invention relates to a method of purifying and recycling water vapor evaporated from a coal drying process and a device used by the same.

### BACKGROUND

At present, water vapor from coal drying process is mostly discharged out into the atmosphere after de-dusting. There are generally two types of de-dusting techniques. One is dry de-dusting techniques, where the water vapor (generally containing a slight amount of non-condensable gas and a micro amount of coal dust) evaporated from the wet coal powder is purified by a bag filter and then directly discharged out into the atmosphere.

By this way, the water vapor is not recycled. The other type is wet de-dusting techniques, where the water vapor (generally containing a slight amount of non-condensable gas and a micro amount of coal dust) evaporated from the coal powder is lowered in temperature and de-dusted by way of cold water spaying by a wet dust collector and then directly discharged out into the atmosphere. Through this process, a part of water vapor may be recycled. However, a large amount of cold water is required for spraying. Furthermore, the recycled water contains impurities such as coal dust or the like, causing the resulting water quality to fail to meet reuse standards.

### SUMMARY

In view of a large amount of water vapor evaporated during the coal drying process, which has a value for being recycled and reused, an object of the present invention is to provide a method of purifying and recycling water vapor evaporated from a coal drying process. According to the invention, with a set of technique which combines a temperature-lowering and dehumidifying process, a flash distillation stripping process, and a vacuum condensing process, an exhaust gas with high humidity from the coal drying process can be purified and recycled.

Another object of the present invention is to provide a device for purifying and recycling water vapor evaporated from a coal drying process, wherein a key device for the temperature-lowering and dehumidifying technique is a condensed tower for vapor-liquid contact, key devices for the flash distillation stripping technique are a flash distillation tank and a demisting washer, and key devices for the air-cooling technique is a vapor condenser and a water ring vacuum pump.

The objects of the present invention are realized by the following technical solution.

A method for purifying and recycling water vapor evaporated from a coal drying process, comprising:

(a) a step of temperature-lowering and dehumidifying, in which

an exhaust gas of 90˜150° C. with high humidity evaporated from a coal power drying section is preliminarily lowered in temperature in a cooling tube by contacting a condensed water of 40˜100° C. which is from a bottom of a condensed tower and pressured by a cooling water pump, the temperature-lowered exhaust gas then enters into a lower part of the condensed tower, at the same time, a condensed water of 5˜60° C. from a flash distillation tank is pressured by a condensed water pump and then enters into a top of the condensed tower, performing a vapor-liquid reverse contact with the exhaust gas with high humidity in the condensed tower for lowering the temperature of the exhaust gas and dehumidifying the exhaust gas, so that water vapor within the exhaust gas is condensed, wherein the condensed water has a temperature of 40˜100° C. and is accumulated at the bottom of the condensed tower, while non-condensable gas is discharged out via an waste gas induced draft fan;

(b) a step of flash distillation stripping, in which

the condensed water of 40˜100° C. accumulated at the bottom of the condensed tower is pressured by a flash distillation water pump and then pumped into the flash distillation tank for vacuum flash distillation stripping, the condensed water collected through the flash distillation process has a temperature of 5˜60° C., which is pressured and pumped into the condensed tower from a top of the condensed tower by the condensed water pump as a water used in the step of temperature-lowering and dehumidifying, wherein the water vapor of 5˜60° C. evaporated through flash distillation process in the flash distillation tank enters into a demisting washer for being dehumidified and then enters into a vapor condenser for being condensed; and

(c) a step of vacuum condensing, in which

the condensed water of 5˜60° C. through the vacuum condensing process by the vapor condenser enters into a recycled water tank, while non-condensable gas is discharged out via a water ring vacuum pump, wherein process water collected in the recycled water tank can be recycled and reused after pressured by a recycled water pump.

The advantages of the present invention are as follows.

(1) The present invention employs a combination of three kinds of conventional techniques, i.e., temperature-lowering and dehumidifying, flash distillation stripping, and vacuum condensing, to purify and recycle water vapor evaporated from the coal drying process. The devices used can be conventional or standard devices, so that the system is simple with high operability.

(2) In comparison with a conventional wet de-dusting technique, the temperature-lowering and dehumidifying technique according to the present invention needs no complement of additional condensed water, because the condensed water is produced from flash distillation stripping process, so that energy consumption is lowered.

(3) In comparison with the air cooling or water cooling under atmospheric pressure, where the water vapor of 5˜60° C. is hardly to be condensed under atmospheric pressure, the vacuum condensing process according to the invention is performed under a vacuum of 0.0008˜0.020 MPa (A), where condensation points of water vapor of 5˜60° C. is lowered under vacuum, so that it is easy to make water vapor of 5˜60° C. condensed, and therefore a load is also lowered.

(4) In the present invention, the recycled water is condensed from the water vapor obtained by evaporation, having high purification and being equivalent to distilled water and having a wide range for reusing

### BRIEF DESCRIPTION OF THE DRAWINGS

FIG. 1 is a process flow chart of the invention.

The referential numerals are as follows:

| | | |
|---|---|---|
| 1-waste gas induced draft fan | 2-cooling tube | 3-cooling water pump |

| | | |
|---|---|---|
| 4-condensed tower | 5-flash distillation water pump | 6-condensed water pump |

| | | |
|---|---|---|
| 7-demisting washer | 8-flash distillation tank | 9-vapor condenser |
| 10-recycled water tank | 11-recycled water pump | 12-water ring vacuum pump |

FIG. 2 is a block diagram of the invention.

### DETAILED DESCRIPTION

Hereinafter a method of purifying and recycling water vapor evaporated from a coal drying is further described in details in combination with the drawings.

As shown in FIGS. 1-2, an exhaust gas of 90˜150° C. with high humidity (containing a large amount of water vapor and a small amount of non-condensable gas) from a coal power drying section is preliminarily lowered in temperature in a cooling tube 2 by contacting a condensed water of 40˜100° C. which is from a bottom of a condensed tower 4 and pressured by a cooling water pump 3. The temperature-lowered exhaust gas then enters into a lower part of the condensed tower 4. At the same time, a condensed water of 5˜60° C. from a flash distillation tank 8 is pressured by a condensed water pump 6 and then enters into the condensed tower 4 from its top, and vapor-liquid reversely contacts with the exhaust gas with high humidity within the condensed tower 4 to perform a temperature-lowering and dehumidifying process to the exhaust gas. Water vapor in the exhaust gas with high humidity is condensed and accumulated at the bottom of the condensed tower 4, the condensed water having a temperature of 40˜100° C. Non-condensable gas is discharged out via a waste gas induced draft fan 1.

Condensed water of 40˜100° C. accumulated at the bottom of the condensed tower 4 is pressured and pumped by a flash distillation water pump 5 into the flash distillation tank 8 for vacuum flash distillation stripping. The effects of the flash distillation stripping are that, on one hand, water vapor of 5˜60° C. is produced, which is condensed as pure recycled water in a vapor condenser 9, while on the other hand, condensed water of 40˜100° C. is lowered in temperature as condensed water of 5-60° C. Vacuum of 0.0008˜0.020 MPa (A) is produced in the flash distillation tank 8. With flash distillation stripping, the condensed water collected through flash distillation has a temperature of 5˜60° C. and is pressured and pumped by the condensed water pump 6 into the condensed tower 4 as a water for the temperature-lowering and dehumidifying process. The water vapor of 5˜60° C. evaporated through the flash distillation process enters into a demisting washer 7 for being dehumidified, and then enter into the vapor condenser 9 under a suction effect of a water ring vacuum pump 12. A vacuum of 0.0008˜0.020 MPa (A) is produced in the vapor condenser 9. Water vapor evaporated through flash distillation is condensed into pure recycled water of 5˜60° C. under the effect of vacuum condensation and is collected in a recycled water tank 10. The pure water collected in the recycled water tank 10 can be reused after increment in pressure by a recycled water pump 11. Non-condensable gas which cannot be condensed is discharged out by the water ring vacuum pump 12. At the same time, water can be introduced into the water ring vacuum pump 12 for its operation via a pipe from an outlet pipeline of the recycled water pump 11 to the water ring vacuum pump 12. The water which has been used by the pump 12 can return to the recycled water tank 10.

What is claimed is:

1. A method for purifying and recycling water vapor evaporated from a coal drying process, comprising:
(a) a step of temperature-lowering and dehumidifying, in which
an exhaust gas of 90˜150° C. with high humidity evaporated from a coal power drying section being preliminarily lowered in temperature in a cooling tube by contacting a condensed water of 40˜100° C. which is from a bottom of a condensed tower and is pressured by a cooling water pump, the temperature-lowered exhaust gas then entering into a lower part of the condensed tower, at the same time, a condensed water of 5˜60° C. from a flash distillation tank being pressured by a condensed water pump and then entering into a top of the condensed tower, performing vapor-liquid reverse contact with the exhaust gas with high humidity in the condensed tower for lowering the temperature of the exhaust gas and dehumidifying the exhaust gas, so that water vapor within the exhaust gas is condensed, wherein the condensed water has a temperature of 40˜100° C. and is accumulated at the bottom of the condensed tower, while non-condensable gas is discharged out via an waste gas induced draft fan;
(b) a step of flash distillation stripping, in which
the condensed water of 40˜100° C. accumulated at the bottom of the condensed tower is pressured by a flash distillation water pump and then pumped into the flash distillation tank for vacuum flash distillation stripping, the condensed water collected through the flash distillation process having a temperature of 5˜60° C., which is then pressured and then pumped into the condensed tower from a top of the condensed tower by the condensed water pump as a water used in the step of temperature-lowering and dehumidifying, the water vapor of 5˜60° C. evaporated through flash distillation process in the flash distillation tank entering into a demisting washer for being dehumidified and then enter into a vapor condenser for being condensed;
(c) a step of vacuum condensing, in which
the condensed water of 5˜60° C. through the vacuum condensing process by the vapor condenser enters into a recycled water tank, while non-condensable gas is discharged out from the flash distillation tank and the vapor condenser by a water ring vacuum pump.

2. The method for purifying and recycling water vapor evaporated from a coal drying process of claim 1, wherein a condensing medium for the vapor condenser is selected from the group consisting of air, cooling water, sea water, industrial recycled water, and wherein vapor condenser employs a forced cooling or a natural air cooling.

3. A device for implementing the method of claim 1, comprising:
a waste gas induced draft fan for discharging out non-condensable gas from a condensed tower;
a cooling tube in which an exhaust gas of 90˜150° C. with high humidity is preliminarily lowered in temperature and introduced into the condensed tower;
a cooling water pump for pressuring and pumping condensed water of 40˜100° C. from a bottom of the condensed tower into the cooling tube;
the condensed tower for receiving the exhaust gas with high humidity from the cooling tube and a condensed water of 5˜60° C. pumped from a flash distillation tank by a condensed water pump to perform a vapor-liquid reverse contact for lowering the temperature of the exhaust gas and dehumidifying the exhaust gas, the producing condensed water being of 40˜100° C.;
a flash distillation water pump for pressuring and pumping the condensed water of 40˜100° C. from the bottom of the condensed tower into the flash distillation tank;
the condensed water pump for pressuring and pumping the condensed water of 5˜60° C. from the flash distillation tank into the condensed tower;
a demisting washer, in which the water vapor of 5˜60° C. evaporated through flash distillation in the flash distillation tank is dehumidified and then transferred into a vapor condenser to be condensed;
the flash distillation tank for performing a vacuum flash distillation on the condensed water of 40˜100° C. that is pumped therein by the flash distillation water pump, so as to produce a water vapor of 5˜60° C. which is introduced into the demisting washer and a condensed water of 5˜60° C. which is pressured and pumped into the condensed tower by the condensed water pump;
the vapor condenser, into which the water vapor of 5˜60° C. evaporated from flash distillation in the flash distillation tank enters for being condensed after said water vapor is dehumidified by the demisting washer;
a recycled water tank for storing water of 5˜60° C. condensed from the vapor condenser;
a recycled water pump for pressured and conveying the condensed water from the recycled water tank; and
a water ring vacuum pump for discharging out non-condensable gas and recycling condensed water into the recycled water tank.

4. The device of claim 3, wherein the condensed tower employs a sieve-tray tower, a packed tower or a spray tower, or other vapor-liquid reverse contact device.
